(19) United States
(12) Patent Application Publication
(10) Pub. No.: US 2005/0080647 A1
(43) Pub. Date: Apr. 14, 2005

(54) Business process diagnostic method and business process diagnostic system

(76) Inventors: Koji Okada, Yokohama (JP); Tatsuya Suzuki, Yokohama (JP); Asahiro Kuni, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/929,418

(22) Filed: Aug. 31, 2004

(30) Foreign Application Priority Data
Oct. 2, 2003 (JP) 2003-343915

(51) Int. Cl. G06F 17/60

(52) U.S. Cl. 705/1; 705/10

(57) ABSTRACT

In business process diagnosis, answers to questions is improved in their accuracy, and an accurate result of diagnosis is obtained. A computer diagnoses a business process of an organization based on answers to questions. The diagnosis includes a first answer reception step in which a first question sheet containing common questions is displayed to receive answers to said common questions and to receive questions proper to the organization, and then a second question sheet containing said common questions, said answers to the common questions, and said questions proper to the organization is generated; a second answer reception step in which said second question sheet is displayed to receive answers to said questions proper to the organization, and then a third question sheet containing said common questions, said answers to the common questions, said questions proper to the organization, and said answers to the questions proper to the organization is generated; and a diagnosis step in which the business process of said organization is diagnosed based on the answers to said common questions and the answers to said questions proper to the organization, with said answers to said common questions and said answers to said questions proper to the organization being filled in said third question sheet.

### BACKGROUND OF THE INVENTION

The present invention relates to a technique of diagnosing a business process of an organization. Recently, promotion of improvement of a business process of an organization is attempted by diagnosing the business process and presenting its improvement method. As an example, process improvement by acquisition of ISO-9001 and ISO-14000 and by internal inspection may be mentioned. As another example, appraisal of CMM (Capability Maturity Model), CMMI (Capability Maturity Model Integration), or ISO-15504 to extract weak points in a business process may be mentioned. As other examples, there are methods based on a business process diagnosis model determined originally. In an inspection of ISO-9001, appraisal of CMM or CMMI, or the like, a business process is diagnosed by means of a combination of a definition of a business process of an organization, inspection of documents made according to that business process, interview examination of persons who carry out the business process, and the like. As a result, many preparation and operation man-hours are required for diagnosis. Thus, business process diagnostic methods based on answers to a simpler questionnaire have been developed.

For example, Japanese Patent Laid-Open Publication No. 2002-109081 discloses a system in which a questionnaire for business diagnosis is provided through a network to prompt input of reply and a business diagnosis result is presented based on a result of the reply. Further, as another example, it is considered to provide a service in which a questionnaire for diagnosis of a corporate climate is provided through a network and a diagnostic result is presented.

### SUMMARY OF THE INVENTION

In the case where a business process of an organization is diagnosed based on a result of reply to a questionnaire as described above, when it is intended that a common questionnaire is prepared for various organizations, it is unavoidable to prepare an abstract questionnaire since a business process is different for each organization. Thus, sometimes a questionnaire is so abstract for a process worker who works actually according to a business process that he wavers in his judgment on the meaning of the questionnaire. On the other hand, for a process definer who defines a business process and performs process-improving activities, it is possible to answer questions relating to the defined business process, but it is difficult to answer questions relating to an actual working state, since he does not work actually according to the business process. Thus, there is a problem that accuracy of answers to a questionnaire is injured and a result of diagnosis becomes readily inaccurate.

The present invention has been made considering the above-described states, and is to provide a technique of increasing accuracy of reply to a questionnaire.

To solve the above problems, the present invention provides a method in which a question sheet containing common questions is presented to a process definer to receive answers to the common questions and to receive questions proper to the organization from the process definer. Further, a question sheet containing the common questions, the answers to the common questions, and questions proper to the organization is presented to a process worker to receive answers to the questions proper to the organization from the process worker.

For example, the present invention provides a business process diagnostic method wherein a computer diagnoses a business process of an organization based on answers to questions, said method comprising: a first answer reception step in which a first question sheet containing common questions is displayed to receive answers to said common questions and to receive questions proper to the organization, and then a second question sheet containing said common questions, said answers to the common questions, and said questions proper to the organization is generated; a second answer reception step in which said second question sheet is displayed to receive answers to said questions proper to the organization, and then a third question sheet containing said common questions, said answers to the common questions, said questions proper to the organization, and said answers to the questions proper to the organization is generated; and a diagnosis step in which the business process of said organization is diagnosed based on the answers to said common questions and the answers to said questions proper to the organization, with said answers to said common questions and said answers to said questions proper to the organization being filled in said third question sheet.

According to the present invention, it is easy for each of a process definer and a process worker to answer questions, and thereby the answers are improved in their accuracy.

### BRIEF DESCRIPTION OF THE DRAWINGS

FIG. 1 shows an example of a question sheet used for diagnosis of a business process of an organization;

FIG. 2 is a flowchart for explaining a business process diagnostic method according to a first embodiment of the present invention;

FIG. 3 shows an example of a question sheet for a process definer, in which common questions have been filled;

FIG. 4 shows an example of a question sheet for process worker, in which common questions, answers to the common questions, and questions proper to the organization have been filled;

FIG. 5 shows an example of a question sheet in which answers by a process definer and a process worker have been filled;

FIG. 6 is a schematic diagram showing a business process diagnostic system to which a second embodiment of the present invention is applied; and

FIG. 7 is a diagram for explaining an operation flow of a server apparatus 610 shown in FIG. 6.

### DETAILED DESCRIPTION

[First Embodiment]

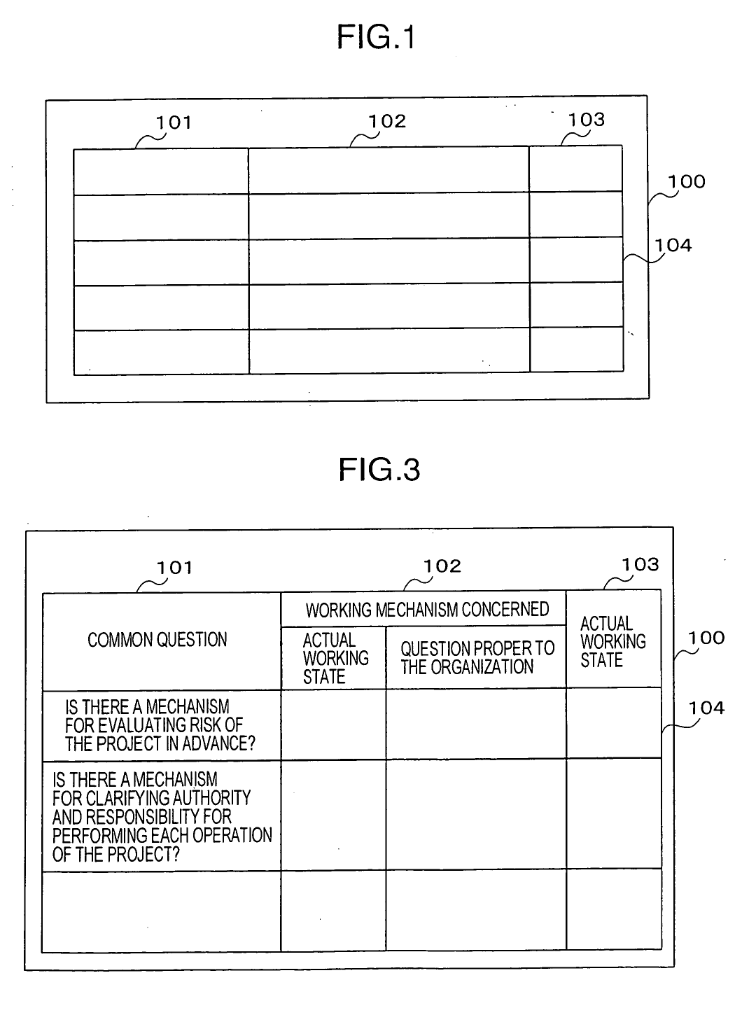

A first embodiment of the present invention will be described taking an example where a business process is diagnosed using an application such as a spreadsheet tool, i.e., which is a program executed by a computer. In the present embodiment, a question sheet (input form data) is prepared by using a spreadsheet tool or the like and answers are filled in the question sheet. For example, a question sheet 100 having at least one question/answer column 104 as shown in FIG. 1 is used for collecting answers required for diagnosing a business process from a process definer and process workers. The question/answer column 104 of the question sheet 100 shown in FIG. 1 includes an entry 101 in which a common question has been filled, an entry 102 in which an answer to the question filled in the entry 101 is filled or selected and a more detailed question related to the question filled in the entry 101, which is proper to an organization, is filled, and an entry 103 in which an answer to the question filled in the entry 102, which is proper to the organization, is filled or selected.

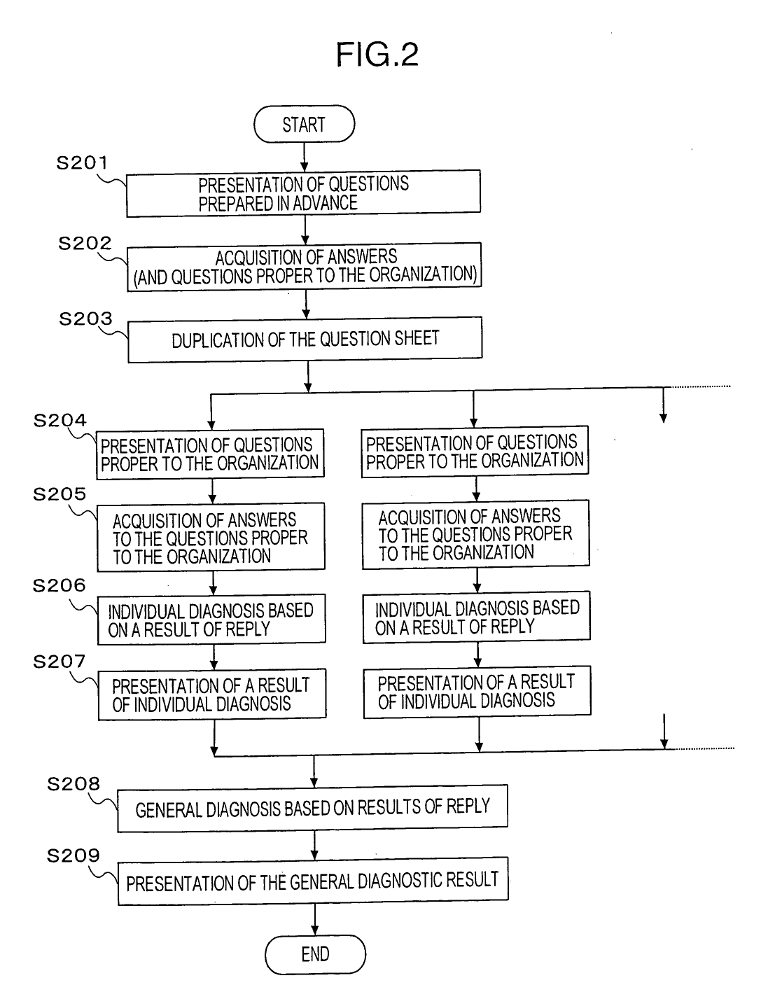

FIG. 2 is a flowchart for explaining a business process diagnostic method according to the first embodiment of the present invention.

In the step S201, a process definer, who has defined the business process and performs process-improving activities, makes an application such as a spread sheet tool present(display) a question sheet 100 prepared in advance as shown in FIG. 3. Entries 101 of the question sheet 100 in which questions directed to the process definer are previously filled.

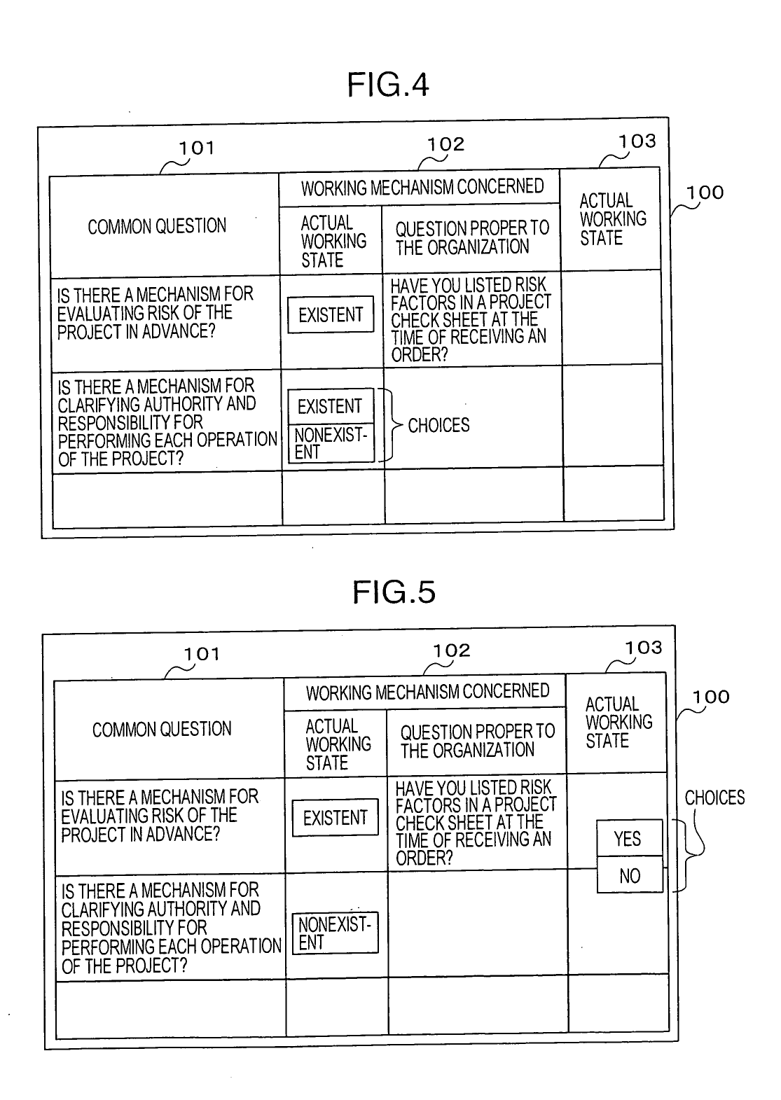

In the step S202, the process definer fills with answers to those questions and also fills with questions proper to the organization in entries 102 of the question sheet 100 presented by the application such as a spread sheet. For example, as shown in FIG. 4, in the case where a common question “Is there a mechanism for evaluating risk of the project in advance?” has been filled in advance in an entry 101 of the question sheet 100 presented, and the process definer has defined the mechanism, the process definer fills with “Existent” in “Actual working state” of “Working mechanism concerned” of the entry 102. Or, among choices “Existent” and “Nonexistent” which have been filled in advance in “Actual working state”, “Existent” is marked. Further, in “Question proper to the organization” of “Working mechanism concerned” of the entry 102, the process definer fills with a question such as, for example, “Have you listed risk factors in a project check sheet at the time of receiving an order”, which is proper to the organization and directed to a process worker who actually carries out the mechanism defined by the process definer.

On the other hand, as shown in FIG. 4, in the case where the process definer has not defined a mechanism such as mentioned in the common question “Is there a mechanism for evaluating risk of the project in advance?” filled in advance in the entry 101 of the question sheet 100 presented, the process definer fills with “Nonexistent” in “Actual working state” of “Working mechanism concerned”. Or, among the choices “Existent” and “Nonexistent” filled in advance in “Actual working state”, “Nonexistent” is marked.

In the step S203, if necessary, the process definer makes the application such as a spreadsheet duplicate the question sheet 100 obtained as a result of the step S202. And, the process definer distributes a duplicate of the question sheet 100 to each of the process workers.

In the step S204, a process worker, who actually works according to the business process, makes the application such as a spreadsheet present (display) the duplicate of the question sheet 100 (See FIG. 4) distributed from the process definer.

In the step S205, the process worker fills with answers in entries 103 of the duplicate of the question sheet 100 presented by the application such as a spread sheet. For example, as to the question proper to the organization, i.e., “Have you listed risk factors in a project check sheet at the time of receiving an order” which has been filled in by the process definer and is seen in the entry 102 of the presented duplicate of the question sheet 100, as shown in FIG. 5, if the process worker has listed the risk factor, then, the process worker fills with “Yes” in “Actual working state”, i.e., the entry 103. Or, among choices “Yes” and “No” fills in advance in “Actual working state”, “Yes” is marked.

In the step S206, the process worker makes the application such as a spreadsheet diagnose the business process of the organization to which the process worker belongs, based on the answers filled in the duplicate of the question sheet 100 (i.e., the answers obtained in the steps S201-S205). For example, in the case where, as an answer of the process definer to a common question, “Nonexistent” is filled or marked in “Actual working state” of the entry 102 in the duplicate of the question sheet 100, then 0 point is given. On the other hand, in the case where “Existent” is filled or marked, then 2 points are given. Further, in the case where, as an answer of the process worker to a question proper to the organization, “No” is filled or marked in “Actual working state”, i.e., the entry 103, then 0 point is given. On the other hand, in the case where “Yes” is filled or marked, then 1 point is given. The total of points given as described above is calculated, and taken as a result of diagnosis of the business process of the organization to which the process worker belongs, to whom the duplicate of the question sheet 100 has been distributed.

In the step S207, the process worker makes the application such as a spreadsheet tool present the result of diagnosis of the business process of the organization, which was calculated in the step S206. Further, the process worker returns the duplicate of the question sheet 100 with the entry 103 containing the answer, to the process definer.

In the step S208, the process definer makes the application such as a spreadsheet tool generally diagnose the business process of the organization as a whole, based on the answers filled in the duplicates of the question sheet 100 returned respectively from the process workers. For example, the application such as a spreadsheet is used to obtain an average and a variance of the organization's business process diagnostic results calculated in the steps S206 for the respective process workers (the respective duplicates of the question sheet 100), and these average and variance are taken as the general diagnosis on the business process of the organization as a whole.

In the step S209, the process definer makes the application such as a spreadsheet present (display) the general diagnostic result on the business process of the organization as a whole, which has been calculated in the step S208.

In the flow shown in FIG. 2, only one of the steps S206 and S208 may be performed. In the case where the step S206 is not performed, also the step 207 is not performed, of course. In the case where the step S208 is not performed, also the step 209 is not performed, of course.

Further, although the above embodiment has been described taking the example where an application such as a spreadsheet is used for diagnosing a business process, the present invention is not limited to this. It is possible to use a paper-made question sheet 100 for diagnosing a business process.

[Second Embodiment]

A second embodiment of the present invention will be described taking an example where a business process is diagnosed using a computer system that includes a client terminal connected with a server apparatus through a network.

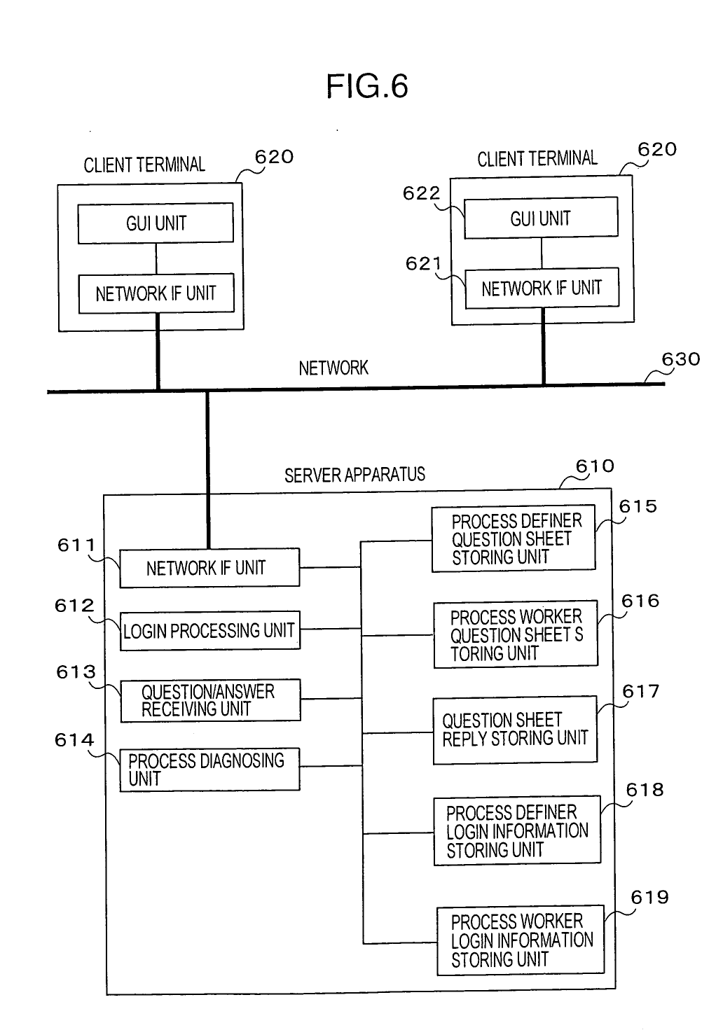

FIG. 6 is a schematic diagram showing a business process diagnostic system to which the second embodiment of the present invention is applied. As shown in the figure, the business process diagnostic system of the present embodiment comprises a server apparatus 610 and at least one client terminal 620 connected with the server apparatus 610 through a computer network 630. Here, the server apparatus 610 may be provided with a configuration of a client terminal 620 so as to function as a client terminal 620 also.

The client terminal 620 comprises a network IF (interface) unit 621 and a GUI (Graphical User Interface) unit 622. The network IF unit 621 is an interface for connecting the client terminal 620 to the computer network 630. The GUI unit 622 displays information received from the server apparatus 610 through the network IF unit 621 and sends information received from a user of the client terminal 620 to the server apparatus 610 through the network IF unit 621.

The server apparatus 610 comprises a network IF unit 611, a login processing unit 612, a question/answer receiving unit 613, a process diagnosing unit 614, a process definer question sheet storing unit 615, a process worker question sheet storing unit 616, a question sheet reply storing unit 617, a process definer login information storing unit 618, and a process worker login information storing unit 619.

The network IF unit 611 is an interface for connecting the server apparatus 610 to the computer network 630. The login processing unit 612 performs login processing of a user of the client terminal 620. The question/answer receiving unit 613 presents the question sheet 100 described in the first embodiment to the client terminal 620, to receive information such as questions, answers, and the like. The process diagnosing unit 614 makes a diagnosis on the business process, based on the answers received from the client terminal 620 through the question/answer receiving unit 613. The process definer question sheet storing unit 615 stores the question sheet 100 (See FIG. 3) that is to be presented to the process definer and contains common questions. The process worker question sheet storing unit 616 stores the question sheet 100 (See FIG. 4) that is to be presented to the process workers. In this question sheet 100, the process definer has filled with answers to the common question, and has filled with questions proper to the organization. The question sheet reply storing unit 617 stores the question sheet 100 (See FIG. 5) for each process worker. This question sheet 100 contains the answers to the common questions and contains the questions proper to the organization, which are filled by the process definer, and also contains answers to the questions proper to the organization, which are filled by the process worker in question. The process definer login information storing unit 618 stores login information (a login name and a password) for the process definer to use the server apparatus 610. And, the process worker login information storing unit 619 stores login information (a login name and a password) for each process worker to use the server apparatus 610.

Here, each of the client terminals 620 and the server apparatus 610 shown in FIG. 6 is implemented by an ordinary computer system comprising a CPU, a memory, an external storage such as a HDD, a reader for reading data from a storage medium such as a CD-ROM, and a communication device for connecting to the network 630, when the CPU loads a predetermined program stored in the external storage or a storage medium onto the memory and executes the program. In a client terminal 620, a Web browser program, a dedicated client program or the like is used as the predetermined program, for example. In the server apparatus 610, a Web server program, a dedicated server program, a groupware program or the like is used as the predetermined program, for example. Further, the communication device is used as the network IF unit 621 or 611 of the client terminal 620 or the server apparatus 610. As the storing units 615-619 of the server apparatus 610, the external storage or a storage medium is used.

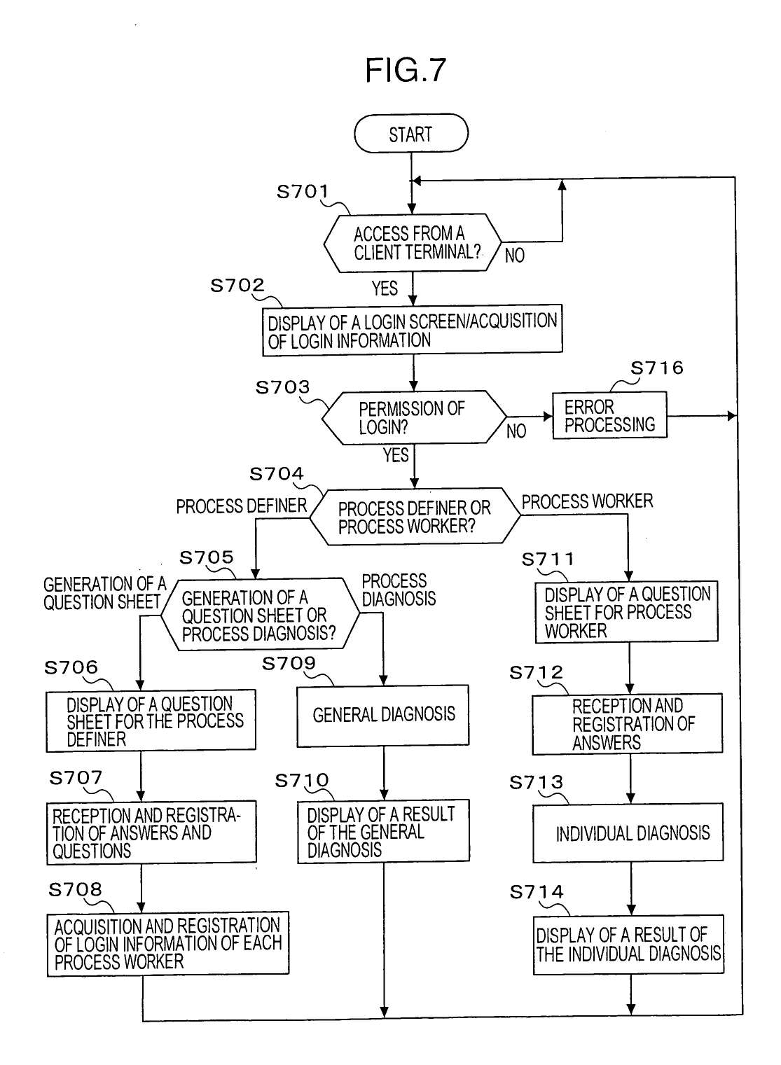

FIG. 7 is a diagram for explaining an operation flow of the server apparatus 610 shown in FIG. 6.

In the server apparatus 610, when the network IF unit 611 is accessed from a client terminal 620 through the computer network 630 (YES in the step S701), the login processing unit 612 sends login input screen data (which is used for receiving login information from a user of the client terminal 620) to the client terminal 620 as the access source through the network IF unit 611. In the client terminal 620, the GUI unit 622 displays the login input screen data received from the server apparatus 610 through the network IF unit 621, to receive the login information (a login name and a password) from the user. Then, the received login information is sent to the server apparatus 610 through the network IF unit 621. Then, in the server apparatus 610, the login processing unit 612 receives the login information from the client terminal 620 through the network IF unit 611 (the step S702).

Next, the login processing unit 612 examines whether the login information received from the client terminal 620 is stored in either the process definer login information storing unit 618 or the process worker login information storing unit 619, to judge whether the login of the user of the client terminal 620 should be permitted (the step S703).

In the case where, in the step S702, the login information received from the client terminal 620 is stored in neither the process definer login information storing unit 618 nor the process worker login information storing unit 619, then predetermined error processing is performed such that, for example, an error message indicating rejection of the login is sent to the client terminal 620 as the sender of the login information, through the network IF unit 611, to make the client terminal 620 display an error indication (the step S716). Then, the flow returns to the step S701.

On the other hand, in the step S703, in the case where the login information received from the client terminal 620 is stored in either the process definer login information storing unit 618 or the process worker login information storing unit 619, then the login processing unit 612 permits the login. In the case where the login information received from the client terminal 620 is stored in the process definer login information storing unit 618, then it is judged that the user of the client terminal 620 is the process definer, and the flow proceeds to the step S705. On the other hand, the login information received from the client terminal 620 is stored in the process worker login information storing unit 619, then it is judged that the user of the client terminal 620 is a process worker, and the flow proceeds to the step S711.

In the step S705, the question/answer receiving unit 613 sends selection screen data for making a user select either generation of a question sheet or diagnosis of the business process to the client terminal 620 of the process definer, for which the login has been permitted, through the network IF unit 611. In the client terminal 620, the GUI unit 622 displays the selection screen data received from the server apparatus 610 through the network IF unit 621, to make the user, i.e., the process definer, select either generation of a question sheet or diagnosis of the business process. Then, a selection result is sent to the server apparatus 610 through the network IF unit 621. In the server apparatus 610, the question/answer receiving unit 613 receives the selection result from the client terminal 620 through the network IF unit 611. In the case where the selection result indicates a selection of generation of a question sheet, then the flow proceeds to the step S706. On the other hand, in the case where the selection result indicates a selection of diagnosis of the business process, then the flow proceeds to the step S709.

In the step S706, the question/answer receiving unit 613 reads the question sheet 100 (See FIG. 3) containing the common questions from the process definer question sheet storing unit 615, and sends the question sheet 100 to the client terminal 620 of the process definer, for which the login has been permitted, through the network IF unit 611. In the client terminal 620, the GUI unit 622 displays the question sheet 100 (for the process definer) received from the server apparatus 610 through the network IF unit 621, to receive answers and questions proper to the organization, which are to be filled in entries 102 of the question sheet 100, from the user, i.e., the process definer. Then, the received answers and questions proper to the organization are sent together with identification information of the entries 102 in which these answers and questions are to be filled, to the server apparatus 610 through the network IF unit 621. Next, in the server apparatus 610, when the question/answer receiving unit 613 receives the answers and the questions proper to the organization together with the identification information of the entries 102 in which these answers and questions are to be filled, from the client terminal 620 of the process definer (whose login has been permitted) through the network IF unit 611, then a question sheet 100 for process worker (See FIG. 4) is generated by filling with the answers and the questions proper to the organization in the corresponding entries 102 of the question sheet 100 read from the process definer question sheet storing unit 615. The generated question sheet 100 is stored into the process worker question sheet storing unit 616 (the step S707), and the flow proceeds to the step S708.

In the step S708, the question/answer receiving unit 613 sends process worker input screen data for receiving login information of each process worker to the client terminal 620 of the process definer whose login has been permitted. In the client terminal 620, the GUI unit 622 displays the process worker input screen data received from the server apparatus 610 through the network IF unit 621, to receive login information (a login name and a password) of each process worker whose answers are to be collected, from the user, i.e., the process definer. Then, the received login information of each process worker is sent to the server apparatus 610 through the network IF unit 621. In the server apparatus 610, the question/answer receiving unit 613 receives the login information of each process worker whose answers are to be collected, from the client terminal 620 of the process definer whose login has been permitted, through the network IF unit 611. The received login information is registered in the process worker login information storing unit 619.

In the step S711, the question/answer receiving unit 613 reads the question sheet 100 (See FIG. 4) containing the common questions, the answers to those common questions and the questions proper to the organization, from the process worker question sheet storing unit 616, and sends that question sheet 100 to the client terminal 620 of the process worker whose login has been permitted, through the network IF unit 611. In the client terminal 620, the GUI unit 622 displays the question sheet 100 for process worker, which is received from the server apparatus 610 through the network IF unit 621, in order to receive answers to be filled in entries 103 of the question sheet 100 from the user, i.e., the process worker. Then, together with identification information of the entries 103 in which the received answers are to be filled, the received answers are sent to the server apparatus 610 through the network IF unit 621. Next, in the server apparatus 610, when the question/answer receiving unit 613 receives the answers together with the identification information of the entries 103 from the client terminal 620 of the process worker whose login has been permitted, through the network IF unit 611, then, an answered question sheet 100 (See FIG. 5) is generated by filling with the answers to the respective entries 103 of the question sheet 100 read from the process worker question sheet storing unit 616, and the generated question sheet 100 is stored in the question sheet reply storing unit 617, being associated with the login information of the process worker whose login has been permitted (the step S712). Then, the flow proceeds to the step S713.

In the step S713, the process diagnosing unit 614 makes an individual diagnosis on the business process of the organization to which the process worker belongs, based on the answered question sheet 100 stored in the question sheet reply storing unit 617 being associated with the login information of the process worker whose login has been permitted. For example, similarly to the first embodiment (the step S206 of FIG. 2), in the case where, as an answer of the process definer to a common question, “Nonexistent” is filled in or marked in “Actual working state” of the entry 102, then 0 point is given. On the other hand, in the case where “Existent” is filled in or marked, then 2 points are given. Further, in the case where, as an answer of a process worker of the organization to a question proper to the organization, “No” is filled in or marked in “Actual working state” of the entry 103, then 0 point is given. On the other hand, in the case where “Yes” is filled in or marked, then 1 point is given. The total of points given as described above is calculated, and taken as a result of individual diagnosis) of the business process of the organization to which the process worker whose login has been permitted belongs. Then, the process diagnosing unit 614 sends the result of individual diagnosis of the business process, which has been calculated in the step S713, to the client terminal 620 of the process worker whose login has been permitted, through the network IF unit 611 (the step S714). Receiving the result, the GUI unit 622 of the client terminal 620 displays the result of the individual diagnosis of the business process, which is received from the server apparatus 610 through the network IF unit 621. Thereafter, the flow returns to the step S701.

In the step S709, the process diagnosing unit 614 makes a general diagnosis on the business process of the organization as a whole, based on the answered question sheet 100 stored in the question sheet reply storing unit 617 for each process worker. For example, for each answered question sheet 100, processing similar to the step S713 is performed for making an individual diagnosis of the business process. Then, similarly to the first embodiment (the step S208 of FIG. 2), an average and a variance of the individual diagnosis results of the business process for the respective answered question sheets 100 are calculated, and taken as a general diagnosis on the business process of the organization as a whole. Here, as a percentage of reply to the question sheet, may be calculated a ratio of the number of the answered question sheets stored in the question sheet reply storing unit 617 to the number of process workers stored in the process worker login information storing unit 619. Then, the process diagnosing unit 614 sends the general diagnostic result of the business process (or the general diagnostic result and the percentage of reply to the question sheet), which has been calculated in the step S709, to the client terminal 620 of the process definer whose login has been permitted, through the network IF unit 611 (the step S710). Receiving this result, the GUI unit 622 of the client terminal 620 displays the general diagnostic result of the business process (or the general diagnostic result and the percentage of reply to the question sheet) received from the server apparatus 610 through the network IF unit 621. Thereafter, the flow returns to the step S701.

In the flow shown in FIG. 7, only one of the steps S709 and S713 may be performed. In the case where the step S713 is not performed, also the step S714 is not performed, of course. In the case where the step S709 is not performed, also the step S710 is not performed, of course.

Hereinabove, the embodiments of the present invention have been described.

According to the embodiments of the present invention, a question sheet 100 containing common questions is presented to a process definer. In the question sheet 100, it is sufficient for the process definer to fill with answers to the common questions and to fill with questions proper to the organization. In other words, the process definer does not need to answer detailed questions that are difficult to answer unless he actually works according to the business process. Further, according to the embodiments of the present invention, a question sheet 100 containing the common questions, the answers to the common questions, and the questions proper to the organization is presented to each process worker. In the question sheet 100, it is sufficient for a process worker to fill with answers to the questions proper to the organization. In other words, the process worker does not need to answer abstract questions that are difficult to answer unless he is the definer of the business process. Thus, according to the embodiments of the present invention, for each of the process definer and the process workers, it is easy to answer questions, and accordingly, the answers are improved in their accuracy.

The present invention is not limited to the above embodiments, and can be changed variously within the scope of the invention.

1. A business process diagnostic method wherein a computer diagnoses a business process of an organization based on answers to questions, said method comprising:
a first answer reception step in which a first question sheet containing common questions is displayed to receive answers to said common questions and to receive questions proper to the organization, and then a second question sheet containing said common questions, said answers to the common questions, and said questions proper to the organization is generated;
a second answer reception step in which said second question sheet is displayed to receive answers to said questions proper to the organization, and then a third question sheet containing said common questions, said answers to the common questions, said questions proper to the organization, and said answers to the questions proper to the organization is generated; and
a diagnosis step in which the business process of said organization is diagnosed based on the answers to said common questions and the answers to said questions proper to the organization, with said answers to said common questions and said answers to said questions proper to the organization being filled in said third question sheet.

2. A business process diagnostic method according to claim 1, wherein:
in said second answer reception step, said second question sheet is displayed, and each time an answer to said questions proper to the organization is received, said third question sheet is generated; and
in said diagnosis step, the business process of the organization is diagnosed based on the answers to said common questions and the answers to said questions proper to the organization in each third question sheet generated in said second answer reception step.

3. A business process diagnostic method according to claim 1, wherein:
in said diagnosis step, the business process of the organization is diagnosed by calculating a sum total of points corresponding to said answers to the common questions and said answers to the questions proper to the organization.

4. A business process diagnostic method according to claim 1, wherein:
said computer is connected to a network terminal through a network; and
in said first answer reception step, when login information received from said network terminal is predetermined login information, then said first question sheet is displayed on said network terminal to receive answers to the common questions filled in the first question sheet and to receive questions proper to the organization.

5. A business process diagnostic method according to claim 4, wherein:
in said diagnosis step, a result of diagnosis of the business process of the organization is displayed on said network terminal.

6. A business process diagnostic method according to claim 1, wherein:
said computer is connected to a network terminal through a network; and
in said second answer reception step, when login information received from said network terminal is predetermined login information, then said second question sheet is displayed on said network terminal to receive answers to said questions that are proper to the organization and filled in said second question sheet.

7. A business process diagnostic method according to claim 6, wherein:
in said diagnosis step, a result of diagnosis of the business process of the organization is displayed on said network terminal.

8. A business process diagnostic method wherein a business process of an organization is diagnosed based on answers to question, comprising:
a step in which a first question sheet containing common questions is presented to a process definer to make the process definer fill with answers to said common questions and fill with questions proper to the organization, and thereby a second question sheet containing said common questions, said answers to the common questions, and said questions proper to the organization is generated;
a step in which said second question sheet is presented to a process worker to make the process worker fill with answers to said questions proper to the organization, and thereby a third question sheet containing said common questions, said answers to the common questions, said questions proper to the organization, and said answers to the questions proper to the organization is generated; and
a step in which the business process of said organization is diagnosed based on the answers to said common questions and the answers to said questions proper to the organization, with said answers to said common questions and said answers to said questions proper to the organization being filled in said third question sheet.

9. A computer readable program for diagnosing a business process of an organization based on answers to questions, wherein:
a processor of a computer makes said computer execute:
a first answer reception step in which a first question sheet containing common questions is displayed to receive answers to said common questions and to receive questions proper to the organization, and then a second question sheet containing said common questions, said answers to the common questions, and said questions proper to the organization is generated;
a second answer reception step in which said second question sheet is displayed to receive answers to said questions proper to the organization, and then a third question sheet containing said common questions, said answers to the common questions, said questions proper to the organization, and said answers to the questions proper to the organization is generated; and
a diagnosis step in which the business process of said organization is diagnosed based on the answers to said common questions and the answers to said questions proper to the organization, with said answers to said common questions and said answers to said questions proper to the organization being filled in said third question sheet.

10. A business process diagnostic system for diagnosing a business process of an organization based on answers to questions, comprising:
a first question sheet storing means for storing a first question sheet containing common questions;
a second question sheet storing means for storing a second question sheet containing answers to said common questions and containing questions proper to the organization;
a third question sheet storing means for storing a third question sheet containing answers to said common questions, said questions proper to the organization and answers to said questions proper to the organization;
an answer receiving means for performing processing in which said first question sheet stored in said first question sheet storing means is displayed to receive answers to said common questions and then said second question sheet is generated and stored into said second sheet storing means, and processing in which said second question sheet stored in said second question sheet storing means is displayed to receive answers to said questions proper to the organization and then said third question sheet is generated and stored into said third question sheet storing means; and
a diagnosing means for diagnosing said business process of the organization based on the answers to the common questions and the answers to the questions proper to the organization, with said common questions and said questions proper to the organization being filled in said third question sheet.
